(19) United States
(12) Patent Application Publication
(10) Pub. No.: US 2025/0250198 A1
(43) Pub. Date: Aug. 7, 2025

(54) GEOPOLYMER COMPOSITION AND ITS PRODUCTION METHOD

(71) Applicant: TOKUYAMA CORPORATION, Yamaguchi (JP)

(72) Inventors: Takahiro ONISHI, Yamaguchi (JP); Kohei OMURA, Yamaguchi (JP)

(73) Assignee: TOKUYAMA CORPORATION, Yamaguchi (JP)

(21) Appl. No.: 18/856,093

(22) PCT Filed: Apr. 12, 2023
(86) PCT No.: PCT/JP2023/014812

§ 371 Date: Oct. 11, 2024

(30) Foreign Application Priority Data
Apr. 18, 2022 (JP) 2022-068241

(51) Int. Cl. C04B 12/00; C04B 5/06; C04B 18/08; C04B 18/14; C04B 20/02; C04B 22/10; C04B 28/00; C04B 28/26; C04B 103/00

(52) U.S. Cl. CPC C04B 12/005; C04B 5/06; C04B 18/08; C04B 18/141; C04B 20/0232; C04B 22/10; C04B 28/006; C04B 28/26; C04B 2103/0006; C04B 2103/0088

(57) ABSTRACT

It is to provide a powdered-state geopolymer composition comprising an active filler comprising a carbonated slag fine powder and a pozzolanic material powder, an alkali source in a powdered-state comprising at least one selected from alkali metal silicate powder, alkali metal carbonate powder, wherein the carbonated slag fine powder comprises 0.1 mass % or more and 2.0 mass % or less of CO₂, and comprises 0.26 mass % or more and 1.0 mass % or less of bonding water.

### TECHNICAL FIELD

The present invention relates to a technique for retarding setting of geopolymer.

### BACKGROUND ART

Geopolymer is defined as “hardened without using cement clinker, while using a raw material comprising amorphous aluminum silicate as main component (active filler), and at least one type of aqueous solution of silicate, carbonate, hydroxide of alkali metal (alkali source)”, and is an inorganic material having acid resistance, heat resistance, CO₂ suppression, and enabling use of a large amount of industrial by-product, as compared to cement hardened body, and which is application as construction material is expected.

Recently, slag fine powder is used in combination additionally to fly ash as active filler, aiming improvement of strength development or mass transfer resistance under environment of normal temperature, which is the weak point of geopolymer using only fly ash as active filler. However, by using slag fine powder as active filler, the working time (setting time) of geopolymer is reduced to within about 15 to 40 min., and a big problem arises that sufficient time cannot be secured for placement.

Therefore, a method of aiming extending the working time (setting time) of geopolymer, comprising heat treating slag fine powder at 200-1000° C., to obtain a setting retarding-type active filler for geopolymer, and using this active filler to obtain a geopolymer solid body is disclosed by Patent Literature 1. With the method shown in Patent Literature 1, the working time can be extended, but a large decrease in bending strength is generated by heating at 800° C. This is thought to be due to heating the slag crystal structure is changed, and the glass phase in the slag fine powder which is a reaction product of geopolymer reaction has displaced to crystalline material (gehlenite and mavinite) which is reaction inactive. Further, since the total amount of reaction product (glass phase) in the active filler decreases, it is thought that the strength is reduced on a long-term basis. Further, since calcination of slag fine powder at high temperature is necessary, a huge amount of thermal energy is necessary, and incidentally CO₂ emission derived from thermal energy can be estimated, and burden on environmental is large.

### CITATION LIST

### Patent Literature

Patent Literature 1: Japanese Patent Laid-Open Publication No. 2021-031370

### SUMMARY OF INVENTION

### Technical Problem

Geopolymer composition is often used as bonding material of concrete or mortar, as alternative of cement. On the other hand, in case of placement of cement concrete, in case of knead mixing concrete at the factory, transporting with a truck agitator, and performing placement by a concrete pump car, etc. at the site, there is a standard set by the Japan Society of Civil Engineers, and Architectural Institute of Japan stating that the allowable time from the knead mixing of concrete to the termination of placement should be within 120 min. when the outside temperature is 25° C. or less, and within 90 min. when it is over 25° C. Therefore, for using geopolymer concrete for general purpose, a geopolymer composition that maintain a fresh property equal to that of cement concrete after 120 min. from knead mixing is awaited.

The present invention has been made based on such circumstances, and the purpose is to provide a geopolymer composition that can extend its working time to a large extent while maintaining strength development, and which has a low burden on environment, and its production method.

### Solution to Problem

The present inventors made a keen study to obtain a geopolymer composition that can extend its working time to a large extent while maintaining strength development, and which has a low burden on environment. As a result, they found out that by performing carbonation treatment to slag fine powder, an effect of extending the working time (setting time) of geopolymer can be obtained. Further, they found out that the bonding water of slag fine powder generated with the carbonation treatment of slag fine powder contributes to extending the working time.

Specifically, according to the present invention, a geopolymer composition that can extend its working time to a large extent while maintaining strength development, and which has a low burden on environment, and its production method are provided.

Specifically, the first embodiment of the present invention is a geopolymer composition comprising an active filler comprising a carbonated slag fine powder and a pozzolanic material, and an alkali source, wherein the carbonated slag fine powder comprises 0.1 mass % or more and 2.0 mass % or less of CO₂, and comprises 0.26 mass % or more and 1.0 mass % or less of bonding water.

It is preferable that the carbonated slag fine powder comprises 1.0 mass % or more and 2.0 mass % or less of CO₂, and comprises 0.5 mass % or more and 1.0 mass % or less of bonding water.

It is more preferable that the carbonated slag fine powder comprises 1.5 mass % or more and 2.0 mass % or less of CO₂, and comprises 0.75 mass % or more and 1.0 mass % or less of bonding water.

It is preferable that the carbonated slag fine powder is one that has been subjected to carbonation treatment under wet condition wherein 0.5 part by mass or more of water is present with respect to 1 part by mass of slag fine powder.

The second embodiment of the present invention is a powdered-state geopolymer composition wherein an alkali source comprised in the geopolymer composition is in a powdered state, and comprises at least one or more selected from alkali metal silicate powder and alkali metal carbonate powder.

It is preferable that the alkali source is alkali metal silicate powder and alkali metal carbonate powder.

It is preferable that the alkali metal silicate powder is sodium silicate powder. Further, it is preferable that the alkali metal carbonate powder is sodium carbonate powder.

The third embodiment of the present invention is a geopolymer composition comprising the powdered-state geopolymer composition and water.

The fourth embodiment of the present invention is a method for producing a geopolymer composition comprising mixing the powdered-state geopolymer composition and water.

The fifth embodiment of the present invention is a geopolymer hardened body which is a hardened product of the geopolymer composition.

### Advantageous Effects of Invention

By using carbonated slag fine powder comprising bonding water as active filler of geopolymer, it is possible to extend the working time (setting time) to a large extent while maintaining strength development, and to obtain a geopolymer composition having a low burden on environment. Therefore, it can be used as bonding material of concrete, etc. as an alternative of cement, and can be commonly and suitably used intending acid resistance, heat resistance, CO₂ suppression, enabling use of a large amount of industrial by-product, in the constructional industry.

### BRIEF DESCRIPTION OF DRAWING

FIG. 1 is a schematic view of an apparatus related to carbonation treatment of slag fine powder slurry.

FIG. 2 is a schematic view of an apparatus related to evaporation to dryness treatment of carbonated slag fine powder slurry.

### DESCRIPTION OF EMBODIMENTS

In the following the embodiments of the present invention will be explained in detail, while the present invention shall not be limited to these embodiments. Further, “part” or “%” herein mentioned refers to mass standard, unless otherwise defined.

### (Geopolymer Composition)

The geopolymer composition of the present invention comprises an active filler comprising a carbonated slag fine powder and a pozzolanic material, an alkali source, and water, wherein the carbonated slag fine powder comprises 0.1 mass % or more and 2.0 mass % or less of CO₂, and comprises 0.26 mass % or more and 1.0 mass % or less of bonding water.

### (Active Filler)

In the present invention, the active filler comprises a carbonated slag fine powder and a pozzolanic material. The active filler comprises a carbonated slag fine powder and a pozzolanic material as main component, and the total content rate of the carbonated slag fine powder and pozzolanic material in the whole active filler is preferably 90 mass % or more, more preferably 95 mass % or more, and particularly preferable to substantially be 100 mass %.

### (Carbonated Slag Fine Powder)

The carbonated slag fine powder comprised in the active filler is produced by subjecting slag fine powder to carbonation treatment, and comprises 0.1 mass % or more and 2.0 mass % or less of CO₂, and comprises 0.26 mass % or more and 1.0 mass % or less of bonding water. It is necessary for both CO₂ and bonding water to satisfy this range, to extend in a long extent the working time. To further extend the working time, it is preferable that the carbonated slag fine powder comprises 1.0 mass % or more and 2.0 mass % or less of CO₂, and comprises 0.5 mass % or more and 1.0 mass % or less of bonding water. Further, to ensure the working time of the geopolymer composition by supposing transportation with a truck agitator, or an operation time within 120 min. for placement at the site, it is preferable that the carbonated slag fine powder comprises 1.5 mass % or more and 2.0 mass % or less of CO₂, and comprises 0.75 mass % or more and 1.0 mass % or less of bonding water.

Slag fine powder to be the raw material of the carbonated slag fine powder is formed at the same time as the generation of pig iron, and comprises CaO, SiO₂, Al₂O₃, MgO as main components. The types of slag are not particular limited, and can be any of blast furnace slug or steel slug, and granulated blast furnace slag fine powder is preferable from the viewpoint of reactivity. Particularly, it is preferable to use granulated blast furnace slag fine powder in conformity with JIS A 6206, without added with gypsum, and comprises 3 mass % or less of sulfur trioxide and which ignition loss is 3 mass % or less, as raw material from the viewpoint of strength development of the geopolymer hardened body obtained by using carbonated slag fine powder produced by performing carbonation treatment.

### (Method for Producing Carbonated Slag Fine Powder)

As for a method of carbonation of slag fine powder, a method of carbonation in an atmosphere comprising moisture, or a method of injecting CO₂ gas in a state where slag fine powder is immerged in water is known. In a method in an atmosphere, since a relatively long time is necessary for carbonation, productivity at an industrial level cannot be expected. Further, no carbonated slag fine powder comprising sufficient bonding water can be obtained. Therefore, it is critical to perform in wet conditions such as slurry state or a state immerged in water. In a wet method, carbonated slag fine powder can be obtained in a couple of hours, and carbonated slag fine powder comprising sufficient bonding water can be obtained for sure. In a wet method, the mixing ratio of slag fine powder and water is preferably 0.5 part by mass or more of water, more preferably 0.8 part by mass or more, and further preferably 0.9 part by mass or more with respect to 1 part by mass of slag fine powder.

### (Pozzolanic Material)

Pozzolanic material is a material having pozzolanic activity, and specific examples include coal ash, biomass ash, silica fume, volcanic ash, and metakaolin. In the present invention, fly ash such as coal ash, biomass ash, etc. is preferable, and fly ash for concrete is particularly preferable.

Fly ash is a fine ash collected from discharged gas with an ash collector, among coal ash obtained as by-product in coal-burning plant, etc. It is a material that has pozzolanic activity, and comprises SiO₂, Al₂O₃ as main components. It is preferable to be one that is classified into Types I to IV types based on particle size or flow level, in JIS A 6201. The standard of fly ash is not particularly limited, but Type I and Type II which particle size is fine, and have a rich reactivity are preferable. Further, other types of ash can be used in combination.

The content rate of pozzolanic material with respect to the total mass of pozzolanic material and carbonated slag fine powder in the active filler is preferably 50 to 90 mass %, and more preferably 60 to 85 mass %. When it is 50 mass % or more, when it is mixed with water to make a geopolymer composition, it is possible to maintain good flowability, and sufficient workability can be easily obtained, and it is also preferable from the viewpoint of expanding efficient use of pozzolanic material. Further, when it is 90 mass % or less, a good strength development of the geopolymer composition hardened body can be obtained in early material age.

### (Alkari Source)

Alkali source can be any of alkali metal salt or alkaline-earth metal salt, and from the viewpoint of durability of geopolymer hardened body, etc., it is preferable to use salts of alkali metal elements. Further, salts thereof are silicate, hydroxide, carbonate, and the state may be any of liquid and powder, and may be any of anhydrate, hydrate, aqueous solution of the salt. As alkali source, from the viewpoint of cost and strength development, it is more preferable to comprise alkali metal silicate. Using alkali metal silicate by mixing with other salts such as alkali metal carbonate, etc. enables to arbitrary adjust the properties of the geopolymer composition. Examples of alkali metal silicate include sodium silicate (SiO₂/Nao₂ molar ratio: about 1.95 to 3.4), sodium metasilicate (Type 1, Type 2), potassium silicate, potassium metasilicate, and lithium silicate.

In case the geopolymer composition comprises alkali metal silicate, the molar ratio of silicon (Si) comprised in alkali metal silicate, with respect to alkali metal element (AL) comprised in alkali source Si/AL is preferably 0.05 to 0.85. By setting Si/AL to 0.05 or more, contraction of the geopolymer composition hardened body can be reduced, and by setting Si/AL to 0.85 or less, flowability so that the geopolymer composition can be easily used in the fieldwork can be secured. From the above, it is more preferable that Si/AL is 0.2 to 0.75.

The molar ratio of alkali metal element (AL) comprised in alkali source of the geopolymer composition with respect to water (W) AL/W is preferably 0.05 to 0.3. By setting AL/W to 0.05 or more, the compression strength of the geopolymer composition hardened body can be secured even at ordinary temperature, and by setting AL/W to 0.3 or less, flowability so that the geopolymer composition can be easily used in the fieldwork can be secured. From the above viewpoint, it is more preferable that AL/W is 0.05 to 0.18, and further preferable to be 0.08 to 0.12.

In the geopolymer composition of the present invention, various admixtures, mixture materials can be mixed in addition to the above, within a range that it does not impair the function effect of the present invention. For example, publicly known materials used in concrete, such as a fluidizer, shrinkage reducer, antirust agent, water proof material, setting retarder, antifoam agent, dust reducer, colorant, calcium carbonate powder, etc. can be exemplified.

In the geopolymer composition of the present invention, various aggregates can be further added in addition to the above, according to the application of the geopolymer composition. For example, publicly known aggregates used in concrete such as lightweight aggregate, normal aggregate, heavyweight aggregate, limestone aggregate, slug aggregate, silica sand, etc. can be exemplified.

### (Method for Producing Geopolymer Composition)

The geopolymer composition of the present invention can be produced by mixing a predetermined amount of the above-mentioned active filler comprising carbonated slag fine powder and pozzolanic material, alkali source, and water, and according to need various admixture materials, aggregates at the same time or sequentially, and by appropriately kneading the mixture with a kneading apparatus. The kneading apparatus is not particularly limited, and for example, bi-axial forced mixer used for kneading concrete, etc. can be exemplified.

The method for producing a geopolymer composition comprises, for example in case alkali source is in a powdered-state, a powder mixing step of mixing active filler, alkali source in a powdered-state and aggregates as powder, and a kneading step of kneading by introducing water after the powder mixing step. In case alkali source is not in a powdered-state, it comprises a powder mixing step of mixing active filler and aggregates as powder, and a kneading step of kneading by introducing an aqueous solution of alkali source after the powder mixing step. Further, a second kneading step of mixing and kneading admixtures or mixture materials such as fluidizer or retarder, etc. can be provided after the kneading step.

### (Powdered-State Geopolymer Composition)

The powdered-state geopolymer composition of the present invention comprises an active filler comprising a carbonated slag fine powder and a pozzolanic material powder, and an alkali source in a powdered-state comprising at least one selected from alkali metal silicate powder, and alkali metal carbonate powder.

### (Active Filler)

The active filler of the powdered-state geopolymer composition of the present invention is an active filler used for the above-mentioned geopolymer composition, and comprises carbonated slag fine powder and pozzolanic material powder as main components.

### (Alkali Source in a Powdered-State)

The alkali source in a powdered-state of the powdered-state geopolymer composition of the present invention comprises at least one selected from alkali metal silicate powder, and alkali metal carbonate powder.

### (Alkali Metal Silicate Powder)

Examples of alkali metal silicate powder include sodium silicate powder (SiO₂/NaO₂ molar ratio: about 1.95 to 3.4), sodium metasilicate powder (Type 1, Type 2), potassium silicate powder, potassium metasilicate powder, and lithium silicate powder. Since it is excellent in strength development or durability, and is a powder material having a relatively low price, sodium silicate powder (SiO₂/NaO₂ molar ratio: about 1.950 to 2.2, H₂O=about 20 mass %) is preferable.

### (Alkali Metal Carbonate Powder)

Examples of alkali carbonate powder include sodium carbonate powder (Na₂CO₃), potassium carbonate powder (K₂CO₃), lithium carbonate powder (Li₂CO₃), etc. Sodium carbonate powder having a low price, and showing high reactivity to slag fine powder is preferable.

It is sufficient that at least one selected from alkali metal silicate powder, alkali metal carbonate powder is comprised in the alkali source in a powdered-state, while it is preferable from the viewpoint of strength development that it is consisted of alkali metal silicate powder and alkali metal carbonate powder.

In case the powdered-state geopolymer composition comprises alkali metal silicate powder and alkali metal carbonate powder, the molar ratio of silicon (Si) comprised in alkali metal silicate powder and alkali metal carbonate powder, comprised in the alkali source in a powdered-state with respect to alkali metal element (AL) Si/AL is preferably 0.05 to 0.85. By setting Si/AL to 0.05 or more, contraction of the geopolymer composition hardened body can be reduced, and by setting Si/AL to 0.85 or less, flowability so that the geopolymer composition can be easily used in the fieldwork can be secured. From the above, it is more preferable that Si/AL is 0.2 to 0.75.

### (Method for Producing Powdered-State Geopolymer Composition)

The production of powdered-state geopolymer composition comprises, a powder mixing step of mixing carbonated slag fine powder and pozzolanic material powder as active filler, and at least one selected from alkali metal silicate powder and alkali metal carbonate powder as alkali source in a powdered-state as powder. Further, a second powder mixing step of mixing various admixtures such as fluidizer or setting retarder in a powdered-state, etc., aggregates can be provided after the powder mixing step.

The powdered-state geopolymer composition of the present invention can be used as a premix composition. By making it as a premix composition, by mixing the premix composition and water, the geopolymer composition of the present invention can be produced. Specifically, it comprises an active filler comprising carbonated slag fine powder and pozzolanic material powder, an alkali source in a powdered-state comprising at least one selected from alkali metal silicate powder and alkali metal carbonate powder, and water. Further, as a part of constituting raw material when preparing mortar or concrete, etc., the powdered-state geopolymer composition or the geopolymer composition of the present invention can be present.

In the powdered-state geopolymer composition of the present invention, various admixtures, mixture materials in a powdered-state can be mixed in addition to the above, within a range that it does not impair the function effect of the present invention. For example, publicly known materials used in concrete, such as a fluidizer, shrinkage reducer, antirust agent, water proof material, setting retarder, antifoam agent, dust reducer, colorant, calcium carbonate powder, etc. can be exemplified.

In the powdered-state geopolymer composition of the present invention, various aggregates can be further added in addition to the above, according to the application of the geopolymer composition. For example, publicly known aggregates used in concrete such as lightweight aggregate, normal aggregate, heavyweight aggregate, limestone aggregate, slug aggregate, silica sand, etc. can be exemplified.

### (Method for Producing Geopolymer Composition Using a Powdered-State Geopolymer Composition)

The geopolymer composition of the present invention can be produced by mixing a predetermined amount of the above-mentioned powdered-state geopolymer composition and water, and according to need various admixture materials, aggregates at the same time or sequentially, and by appropriately kneading the mixture with a kneading apparatus. The kneading apparatus is not particularly limited, and for example, bi-axial forced mixer used for kneading concrete, etc. can be exemplified.

The method for producing geopolymer composition comprises, for example a powder mixing step of mixing the powdered-state geopolymer composition of the present invention and aggregates as powder, and a kneading step of kneading by introducing water after the powder mixing step. Further, a second kneading step of mixing and kneading admixtures or mixture materials such as fluidizer or setting retarder, etc. can be provided after the kneading step.

### (Method for Producing a Hardened Body of Geopolymer Composition)

By curing the geopolymer composition at a temperature range of 5° C. to 90° C. after the kneading step or second kneading step of the geopolymer composition, a geopolymer composition hardened body which is a hardened body of the geopolymer composition can be obtained. Particularly, when using alkali metal silicate and alkali metal carbonate in combination as alkali source of the geopolymer composition, a geopolymer composition hardened body being excellent in compression strength can be obtained by curing at ordinary temperature of 5 to 35° C. The other curing conditions are not particularly limited, and can be commonly used curing conditions. For example, steam curing, sealed curing, atmospheric curing, water curing, etc. are used.

Since the above-mentioned geopolymer composition can extend the working time to 120 min. or more while maintaining strength development as compared to well-known geopolymer composition using conventional slag fine powder, it is excellent in operativity and workability. Thus, similarly as cement concrete being a commonly used material, it is possible to perform kneading of the geopolymer composition of the present invention at the factory, transporting with a truck agitator, and performing placement by a concrete pump car, etc. at the site. Further, at the time of carbonation treatment of slag fine powder, calcium, magnesium, etc. and carbonate are formed on the slag particle surface. Thereby, it has an advantage that stabilization and effective use of CO₂ being a greenhouse effect gas are possible. Further, CO₂ gas used for carbon dioxide can be one comprising a constant amount of CO₂ such as industrial discharged gas. Therefore, the geopolymer hardened body obtained by using the geopolymer composition of the present invention has less burden on environment than a conventional geopolymer composition, and can be used for various applications as a bonding material of concrete, in place of cement composition.

### EXAMPLES

In the following, the present invention will be explained in further details, by referring to specific examples. However, the present invention is not limited to the following examples. Unless the features of the present invention are not largely impaired, various deformed examples or applications are also encompassed in the present invention.

### (Raw Material)

### Active Filler

(1) fly ash (FA): Type II fly ash (in conformity to JIS A 6201)
(2) slug fine powder (BFS); furnace slug fine powder 4000 (in conformity to JIS A 6206)
Powder alkali source (alkali metal silicate powder, alkali metal carbonate powder)
(3) powder sodium silicate: sodium silicate powder (SiO₂/Na₂O molar ratio=1.98, H₂O=about 20 mass %, manufactured by our company)
(4) soda ash: sodium carbonate powder (manufactured by our company)

### Other Raw Materials

(5) aggregates: fine aggregates (JIS standard sand)
(6) water: ion exchange water
(7) normal cement: normal Portland cement (in conformity to JIS R 5210)

### [Carbonation Treatment of Slag Fine Powder]

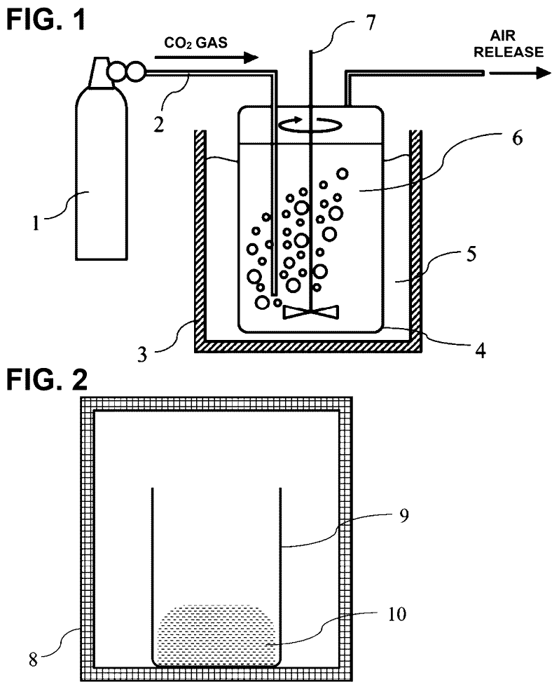

The apparatus that performed carbonation treatment of slag fine powder is shown in FIG. 1.

As shown in FIG. 1, to a 2000 mL gas washing bottle made of polycarbonate (4), 1000 g of slag fine powder slurry (6) (slag fine powder: purified water=mass ratio 1:1) was introduced, passed from CO₂ gas cylinder (1) through inside the nozzle (2), to insufflate CO₂ gas at a predetermined flow rate to the gas washing bottle (4). Inside the gas washing bottle (4), a predetermined temperature was maintained by a constant temperature water tank (3), and in a state of stirring inside the gas washing bottle (4) at 300 min⁻¹ (r.p.m) by using a stirrer (7), carbonation treatment was performed for a predetermined time, to obtain carbonated slag fine powder slurry. After the carbonation treatment, as shown in FIG. 2, carbonated slag fine powder slurry (10) was introduced in a heat resistant container (9), and purified water comprised in the carbonated slag fine powder slurry (10) was evaporated to dryness in the dryer (8). CO₂ amount or bonding water amount could be controlled with the flow rate of carbon dioxide, treatment temperature, mass ratio of slag fine powder with respect to purified water, stirring speed, etc. The carbonation treatment conditions of carbonated slag fine powder BFS-A, BFS-B are shown in the following Table 1.

### [Heating Treatment of Slag Fine Powder]

Slag fine powder was heated and maintained at 400° C. for BFS-400, at 700° C. for BFS-700 and at 800° C. for BFS-800 for 3 hours by using an electrical furnace, and then put outside the furnace to air cooling. The speed of temperature increase from room temperature to each heating temperature is 20° C./min.

### [Quantification Method of CO₂ Amount and Bonding Water Amount]

Carbonated slag fine powder in dried state was subjected to analysis in N2 atmosphere, by using a thermogravimeter-differential thermal analyzer, at a speed of temperature increase of 20° C./min from room temperature to 1000° C.

The mass decrease from room temperature to 500° C. was set as bonding water amount, and the hydrate amount comprised in the carbonated slag fine powder when assuming the hydration product is gehlenite-based hydrate (2CaO·Al₂·O₃·SiO₂·8H₂O, molecular weight 418.3) was also calculated.

Further, the mass decrease from 500° C. to 700° C. was assumed to be caused by CO₂ eliminated by thermal degradation of calcium carbonate, to calculate CO₂ amount and calcium carbonate (molecular weight 100.1) amount respectively from the mass decrease from 500° C. to 700° C. These results are shown in Table 1.

### [Physical Property Values of Carbonated Slag Fine Powder]

The physical property values of the carbonated slag fine powder are shown in the following Table 1.

TABLE 1

| | | | | physical property value | | | |
|---|---|---|---|---|---|---|---|
| | carbonation treatment conditions | | | | | bonding | |
| | | CO₂ | | CO₂ | CaCO₃ | water | hydrate |
| | temperature | flow rate | time | amount | amount | amount | amount |
| Samples | (° C.) | (L/min) | (h) | (mass %) | (mass %) | (mass %) | (mass %) |
| BFS | — | — | — | 0.00 | 0.00 | 0.00 | 0.00 |
| BFS-400 | — | — | — | 0.00 | 0.00 | 0.00 | 0.00 |
| BFS-700 | — | — | — | 0.00 | 0.00 | 0.00 | 0.00 |
| BFS-800 | — | — | — | 0.00 | 0.00 | 0.00 | 0.00 |
| BFS-A | 20 | 0.5 | 0.5 | 1.26 | 2.87 | 0.58 | 13.38 |
| BFS-B | 20 | 0.5 | 2.0 | 1.86 | 4.23 | 0.88 | 20.39 |

### [Preparation of Powdered-State Geopolymer Composition]

Fly ash, various slag fine powder, soda ash, and powder sodium silicate were weighed according to the recipe of the following Table 2, stirred for 3 min. in a polyethylene bag to prepare a powdered-state geopolymer composition having an uniform dispersion state.

TABLE 2

AL (alkali source)

| | normal | P (active filler) | | | | | | | soda | powder |
|---|---|---|---|---|---|---|---|---|---|---|
| | cement | FA | BFS | BFS-400 | BFS-700 | BFS-800 | BFS-A | BFS-B | ash | silicate soda |
| Name | (g) | (g) | (g) | (g) | (g) | (g) | (g) | (g) | (g) | (g) |
| Comparative | 450 | — | — | — | — | — | — | — | — | — |
| Example 1 | | | | | | | | | | |
| Comparative | — | 339.7 | 110.3 | — | — | — | — | — | 17.5 | 92.6 |
| Example 2 | | | | | | | | | | |
| Comparative | — | 339.7 | — | 110.3 | — | — | — | — | 17.5 | 92.6 |
| Example 3 | | | | | | | | | | |
| Comparative | — | 339.7 | — | — | 110.3 | — | — | — | 17.5 | 92.6 |
| Example 4 | | | | | | | | | | |
| Comparative | — | 339.7 | — | — | — | 110.3 | — | — | 17.5 | 92.6 |
| Example 5 | | | | | | | | | | |
| Example 1 | — | 339.7 | — | — | — | — | 110.3 | — | 17.5 | 92.6 |
| Example 2 | — | 339.7 | — | — | — | — | — | 110.3 | 17.5 | 92.6 |
| Example 3 | — | 339.7 | — | — | — | — | — | 110.3 | 17.0 | 89.8 |
| Example 4 | — | 339.7 | — | — | — | — | — | 110.3 | 16.4 | 87.0 |
| Example 5 | — | 339.7 | — | — | — | — | — | 110.3 | 16.2 | 85.6 |
| Example 6 | — | 339.7 | — | — | — | — | — | 110.3 | 15.9 | 84.2 |

| | | | unit | | | |
|---|---|---|---|---|---|---|
| | | | volume | (AL + | | |
| | W | sand | sand | W)/P | AL/W | Si/AL |
| | water | amount | amount | (volume | (molar | (molar |
| Name | (g) | (g) | (kg/m³) | ratio) | ratio) | ratio) |
| Comparative | 225.0 | 1350.0 | 1535.5 | — | — | — |
| Example 1 | | | | | | |
| Comparative | 186.9 | 1512.4 | 1535.5 | 1.17 | 0.103 | 0.708 |
| Example 2 | | | | | | |
| Comparative | 186.9 | 1512.4 | 1535.5 | 1.17 | 0.103 | 0.708 |
| Example 3 | | | | | | |
| Comparative | 186.9 | 1512.4 | 1535.5 | 1.17 | 0.103 | 0.708 |
| Example 4 | | | | | | |
| Comparative | 186.9 | 1512.4 | 1535.5 | 1.17 | 0.103 | 0.708 |
| Example 5 | | | | | | |
| Example 1 | 186.9 | 1512.4 | 1535.5 | 1.17 | 0.103 | 0.708 |
| Example 2 | 186.9 | 1512.4 | 1535.5 | 1.17 | 0.103 | 0.708 |
| Example 3 | 181.2 | 1487.7 | 1535.5 | 1.14 | 0.103 | 0.708 |
| Example 4 | 175.6 | 1463.0 | 1535.5 | 1.10 | 0.103 | 0.708 |
| Example 5 | 172.8 | 1450.7 | 1535.5 | 1.08 | 0.103 | 0.708 |
| Example 6 | 169.9 | 1438.3 | 1535.5 | 1.07 | 0.103 | 0.708 |

* AL/W: molar ratio of alkali metal element (AL) contained in soda ash, powder sodium silicate to water (W)
* Si/AL: molar ratio of silicon (Si) contained in soda ash, powder sodium silicate to alkali metal element (AL)
* (AL + W)/P: volume ratio of the solution in which soda ash, powder sodium silicate are mixed with water, with respect to fly ash, various slag fine powder

### Comparative Example 1

Comparative Example 1 is a mortar using a normal Portland cement being a commonly used material as bonding material. The composition and knead mixing method were in conformity to 11.5 of JIS R 5201:2015 (Physical testing methods for cement).

### Comparative Example 2

Comparative Example 2 is a geopolymer composition using an active filler consisting of slag fine powder which has not been subjected to carbonation treatment or heating treatment and fly ash, and an alkali source consisting of soda ash, powder sodium silicate and water.

### Comparative Examples 3 to 5

Comparative Examples 3 to 5 are geopolymer compositions using an active filler consisting of slag fine powder subjected to heating treatment described in Patent Literature 1 (in case of BFS-400, it means to have been heated at 400° C. for 3 hours) and fly ash, and an alkali source consisting of soda ash and powder sodium silicate. Further, the content of various slag fine powder, AL/W (molar ratio), Si/AL (molar ratio) and (AL+W)/P said to contribute to working time, compression strength, and 15-stroke mortar flow value (flowability) were in conformity with Comparative Example 2.

### Example 1

Example 1 is a geopolymer composition using a powdered-state geopolymer composition using an active filler consisting of carbonated slag fine powder (BFS-A) comprising 1.26 mass % of CO₂, 0.58 mass % of bonding water and fly ash, and an alkali source consisting of soda ash and powder sodium silicate; and water. Further, the content of various slag fine powder, AL/W (molar ratio), Si/AL (molar ratio) and (AL+W)/P said to contribute to working time, compression strength, and 15-stroke mortar flow value (flowability) were in conformity with Comparative Examples 2 to 5.

### Examples 2 to 6

Examples 2 to 6 are geopolymer compositions using a powdered-state geopolymer composition using an active filler consisting of a carbonated slag fine powder (BFS-B) which both CO₂ amount and bonding water amount have been increased, and fly ash, an alkali source consisting of soda ash and powder sodium silicate; and water. Further, the content of various slag fine powder, AL/W (molar ratio), and Si/AL (molar ratio) said to contribute to working time, compression strength, and 15-stroke mortar flow value (flowability) were in conformity with Comparative Examples 2 to 5, and (AL+W)/P was sequentially decreased in Examples 3 to 5.

### [Knead Mixing of Mortar Using Geopolymer Composition]

The above-mentioned powdered-state geopolymer composition and water were put in a Hobart mixer and stirred for 1 min., 1350 g of aggregates were injected to knead mix for 30 sec., and by scraping off for 15 sec., the mixture was further knead mixed for 2 min. to obtain a hydraulic composition knead mixed uniformly as mortar. The 15-stroke mortar flow value, the working time, and the compressive strength of the obtained mortar were measured. The results are shown in Table 3.

### [15-Stroke Mortar Flow Test]

In conformity to mortar flow test described in JIS A 5201, mortar flow values of Comparative Examples 1 to 5 and Examples 1 to 6 after being subjected to 15 times of falling motions immediately after kneading was measured. The results are shown in Table 3.

### [Measurement of Working Time]

At present time, the method for measuring working time is not established. For the cement composition of Comparative Example 1, by performing mortar flow test described in JIS A 5201 every 5 min. immediately after knead mixing to 30 min., and every 10 min. after 30 min., it became less than 130 mm after 120 min, and this was used as standard of determining whether or not it is usable. Similarly, for Comparative Examples 1 to 5 and Examples 1 to 6, it was performed every 5 min. immediately after knead mixing to 30 min., and every 10 min. after 30 min., and the time elapsed to the time point where the flow value became less than 130 mm has been determined to be the working time of the geopolymer composition. The results are shown in Table 3.

### [Compressive Strength Test]

The mortar of Comparative Examples 1 to 5 and Examples 1 to 6 were enclosed in a container having a diameter (Ø) of 50 mm×100 mm, and seal curing was performed at 20° C., until a predetermined material age (day 1, day 7, and day 28).

Compressive strength test was performed to mortar cured until a predetermined material age (day 1, day 7, and day 28), in conformity with the compressive strength test law described in JIS A 1108, to measure the compressive strength. The results are shown in Table 3.

TABLE 3

| | working | 15-stroke | | | | | | |
|---|---|---|---|---|---|---|---|---|
| | time | flow | compression strength (N/mm²)^{※} | | | | | |
| Name | (min) | (mm) | 1 day | | 7 days | | 28 days | |
| Comparative Example 1 | 120 | 177.94 | 10.4 | (—) | 45.3 | (—) | 54.8 | (—) |
| Comparative Example 2 | 15 | 176.19 | 10.3 | (100) | 36.8 | (100) | 54.0 | (100) |
| Comparative Example 3 | 25 | 184.36 | 8.7 | (85) | 34.6 | (94) | 50.8 | (94) |
| Comparative Example 4 | 40 | 186.41 | 5.9 | (57) | 24.6 | (67) | 48.7 | (90) |
| Comparative Example 5 | 120 | 180.41 | not detachable | (0) | 6.8 | (19) | 18.3 | (34) |
| Example 1 | 90 | 188.24 | 8.5 | (83) | 31.6 | (86) | 45.3 | (84) |
| Example 2 | 180 | 199.51 | 8.3 | (81) | 31.1 | (85) | 44.6 | (83) |
| Example 3 | 150 | 181.62 | 8.7 | (84) | 33.2 | (90) | 48.4 | (90) |
| Example 4 | 130 | 172.73 | 9.3 | (90) | 33.6 | (91) | 50.6 | (94) |
| Example 5 | 120 | 171.21 | 9.0 | (88) | 37.2 | (101) | 51.5 | (95) |
| Example 6 | 120 | 163.47 | 9.6 | (93) | 37.6 | (102) | 54.5 | (101) |

* ( ) represents the ratio of compression strength as compared with Comparative Example 2.

As shown in Table 3, in Comparative Examples 2 to 5, according to the extension of working time, the compression strength tended to significantly decrease.

When comparing Example 1 and Example 2, when both bonding water amount and CO₂ amount increase, it has been revealed that the working time could be extended while maintaining strength development.

In Examples 1 to 6, as compared to Comparative Examples 2 to 5, a working time that can sufficiently ensure the operation time of about 90 min. or 120 min. that satisfies the index, etc. of the Japan Society of Civil Engineers, and Architectural Institute of Japan can be obtained, and the strength development is 80% or more as compared to a system using non-treated slag fine powder. Additionally, 15-stroke mortar flow value tends to be improved by carbonation treatment, and it can be seen that the workability of geopolymer composition largely improves.

### REFERENCE SIGNS LIST

(1) CO₂ gas cylinder
(2) nozzle
(3) constant temperature water tank
(4) glass washing bottle
(5) water
(6) slag fine powder slurry
(7) stirrer
(8) dryer
(9) heat resistant container
(10) carbonated slag fine powder slurry

1. A geopolymer composition comprising an active filler comprising a carbonated slag fine powder and a pozzolanic material, an alkali source, and water, wherein the carbonated slag fine powder comprises 0.1 mass % or more and 2.0 mass % or less of CO₂, and comprises 0.26 mass % or more and 1.0 mass % or less of bonding water.

2. The geopolymer composition according to claim 1, wherein the carbonated slag fine powder comprises 1.0 mass % or more and 2.0 mass % or less of CO₂, and comprises 0.5 mass % or more and 1.0 mass % or less of bonding water.

3. The geopolymer composition according to claim 1, wherein the carbonated slag fine powder comprises 1.5 mass % or more and 2.0 mass % or less of CO₂, and comprises 0.75 mass % or more and 1.0 mass % or less of bonding water.

4. The geopolymer composition according to claim 1, wherein the carbonated slag fine powder is a carbonated slag fine powder that has been subjected to carbonation treatment in a wet condition where 0.5 part by mass or more of water is present with respect to 1 part by mass of slag fine powder.

5. A powdered-state geopolymer composition comprising an active filler comprising a carbonated slag fine powder and a pozzolanic material powder, and an alkali source in a powdered-state comprising at least one selected from alkali metal silicate powder, alkali metal carbonate powder,
wherein the carbonated slag fine powder comprises 0.1 mass % or more and 2.0 mass % or less of CO₂, and comprises 0.26 mass % or more and 1.0 mass % or less of bonding water.

6. The powdered-state geopolymer composition according to claim 5, wherein the alkali source consists of alkali metal silicate powder and alkali metal carbonate powder.

7. The powdered-state geopolymer composition according to claim 5, wherein the alkali metal silicate powder is a sodium silicate powder.

8. The powdered-state geopolymer composition according to claim 5, wherein the alkali metal carbonate powder is a sodium carbonate powder.

9. A geopolymer composition comprising the powdered-state geopolymer composition according to claim 5, and water.

10. A method for producing a geopolymer composition, comprising mixing the powdered-state geopolymer composition according to claim 5 and water.

11. A geopolymer composition hardened body, which is a hardened body of the geopolymer composition according to claim 1.

12. A geopolymer composition hardened body, which is a hardened body of the geopolymer composition according to claim 9.
